(19) United States
(12) Patent Application Publication
(10) Pub. No.: US 2017/0014688 A1
(43) Pub. Date: Jan. 19, 2017

(54) GOLF CLUB HEAD HOSEL MARKING

(71) Applicant: DUNLOP SPORTS COMPANY LIMITED, KOBE (JP)

(72) Inventor: KEITH DOLEZEL, COVINA, CA (US)

(21) Appl. No.: 14/802,197

(22) Filed: Jul. 17, 2015

(51) Int. Cl. A63B 53/02; B23K 26/042; B23K 26/08; B23K 26/362; B23K 26/10

(52) U.S. Cl. CPC A63B 53/02; B23K 26/362; B23K 26/103; B23K 26/0823; B23K 26/042

(57) ABSTRACT

A method and a related system of forming laser etched indicia on an external surface of the golf club. The method includes directing a laser beam onto a golf club head, and etching a prescribed indicia into the golf club head. The etching is generated by at least one of: (i) rotating the golf club head relative to the laser beam; and (ii) rotating the laser beam relative to the golf club head.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to golf club heads, and more specifically to markings formed on an arcuate external surface of a golf club head.

2. Description of the Related Art

It is well known in the art to form markings on a golf club. For instance, golf clubs may include markings associated with the geometry of the club head, such as a marking identifying a centerline, which may be useful to the golfer for aligning the club head with the golf ball when the golfer addresses the ball. Furthermore, golf clubs may include one or more markings identifying the “sweet spot” on the striking face. Other markings may include alphanumeric characters corresponding to the relative loft angle of the club within a matched set, i.e., a club may include a “7” formed on the club head of a 7-iron, and a “3” formed on the club head of a 3-wood.

Another marking commonly found on golf clubs, particularly those of the iron type, is a knurled surface extending around the hosel of a club head. The hosel is that portion of the club head extending from the main body thereof and adapted for engagement with the club shaft. Originally, knurling is believed to have been used to provide greater friction between a wooden shaft and a metallic hosel. Knurling may also refer to forging, or cold-working operations, intended to harden the region of the club to which it is applied. In both cases, knurling was typically performed on the club to reduce “play” between the shaft and hosel at impact.

Advancements in club design have diminished the functional need for knurling on the outer surface of the hosel. However, a knurled surface remains an often-sought and traditional visual club head characteristic. Over the years, golfers have associated a knurled surface on a golf club with sophisticated club design and precise club manufacturing. Accordingly, club manufacturers often continue to create a knurled surface on the hosel of the golf club to enhance the appearance of the golf club. Indeed, golfers are more likely to perform better when they feel confident about their equipment, and thus, designers strive to create a golf club which is not only capable of achieving enhanced physical performance, but also communicates a standard of workmanship to the golfer. Knurled surfaces advantageously provide a traditional appearance, particularly in the case of wedges. Many players seek this feature in purchasing a golf club either on a conscious or sub-conscious level. Such knurled golf clubs provide a traditional-appearing club head, which instills confidence in the golfer. The knurling also communicates to the golfer that the club head satisfies design needs enabled by knurling of traditional club heads, thus inducing confidence.

Knurled surfaces are typically formed on the hosel of a golf club using a knurling tool, which includes a knurling wheel rotatably coupled to a handle. The knurling wheel defines the knurled pattern on an outer surface thereof, such that when the knurling wheel is pressed into the surface of the golf club and advanced around the hosel, the knurling pattern is formed on the hosel.

Although conventional knurling tools are capable of forming traditional knurling patterns into the golf club, such knurling tools are typically incapable of forming more complex and intricate designs.

Accordingly, there is a need in the art for a system and method of forming intricate markings on an external surface of a golf club. Various aspects of the present disclosure address this particular need, as will be discussed in more detail below.

### BRIEF SUMMARY

In accordance with one embodiment of the present disclosure, there is provided a golf club having indicia laser etched into an arcuate exterior surface thereof, and a related method of forming the same. Utilizing laser etching for forming the indicia on the club head allows for more intricate indicia patterns and designs and allows for enhanced customization of the golf club.

According to one aspect of the present disclosure, there is provided a method comprising directing a laser beam onto a golf club head, and etching a prescribed indicia into the golf club head. The etching is generated by at least one of: (i) rotating the golf club head relative to the laser beam; and (ii) rotating the laser beam relative to the golf club head.

The method may additionally include the step of etching the prescribed indicia into an arcuate exterior surface of the club head. The club head may further include a hosel having a hosel axis, and the method may additionally comprise the step of etching the prescribed indicia into the hosel of the club head by rotating the club head or laser beam about the hosel axis.

The method may include rotating the golf club head or laser beam at a constant rotational speed, or alternatively, the golf club head or laser beam may be rotated at a variable rotational speed. The rotation of the golf club head or laser beam and the directing of the laser beam onto the exterior surface of the hosel may be controlled and coordinated by computer executable instructions corresponding to the prescribed indicia.

The laser beam may define a beam axis, and the method may include aligning the laser beam with the hosel such that the beam axis extends generally perpendicularly relative to the hosel axis.

The prescribed indicia may be etched into the exterior surface of the hosel about only a portion of the circumference, or alternatively across the entire circumference thereof.

According to another aspect of the present disclosure, there is provided a golf club head comprising a main body including a striking face adapted to strike a golf ball, and a hosel extending from the main body. The hosel includes an exterior surface and defines a hosel axis, with the external surface of the hosel having indicia laser etched thereinto, the indicia circumferentially extending about the hosel axis by about at least 25°.

The indicia may comprise a plurality of indicium forming a recurrent pattern. The recurrent pattern may resemble a knurling pattern.

According to yet another aspect of the present disclosure, there is provided a golf club head comprising a main body including a striking face adapted to strike a golf ball, and a hosel extending from the main body. The hosel includes an exterior surface and defines a hosel axis, wherein the exterior surface of the hosel includes a surface-treatment region thereon constituting indicia resembling a knurling pattern, with the surface-treatment region having a depth no greater than 0.15 mm.

The surface treatment region may be a region selected from a group consisting of: a chemical-etched region, a laser-etched region, a media-blasted region, a transfer-printed region, a painted region, a coated region, a physical vapor deposition region, and an anodization region. The indicia may comprise a width of no less than 0.1 inch.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a rear elevational view of a golf club head and an exemplary indicia design field representative of indicia capable of being formed on the club head;

FIG. 2 is a partial upper perspective view of a golf club head hosel having the indicia of FIG. 1 formed thereon;

FIG. 3 is a side view of a system for laser etching indicia into a surface of the golf club head;

FIGS. 4, 6, 8, and 10 are plan views of various exemplary indicia designs; and

FIGS. 5, 7, 9 and 11 are upper perspective views of golf club hosels having the indicia designs of FIGS. 4, 6, 8, and 10, respectively, formed thereon.

Common reference numerals are used throughout the drawings and the detailed description to indicate the same elements.

### DETAILED DESCRIPTION

The detailed description set forth below in connection with the appended drawings is intended as a description of certain embodiments of a method of forming visual markings on an external surface of a golf club and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to a golf club 10 having indicia formed on one or more prescribed areas or regions of the outer surface thereof. As will be described with greater particularity below, the indicia may be formed on virtually any outer surface region of the golf club 10, including the circumferential outer surface of the hosel of the club head thereof, exterior surfaces of the club head other than its hosel, the outer surface of the club shaft of the golf club 10, etc. According to one embodiment, the indicia is formed on the golf club 10 using a laser beam which is directed upon the outer surface of the golf club 10 while the golf club 10 is rotated. The emission of laser energy and rotation of the golf club 10 may be coordinated or synchronized with each other to create the prescribed indicia, e.g., marking, pattern, or design, on the golf club 10.

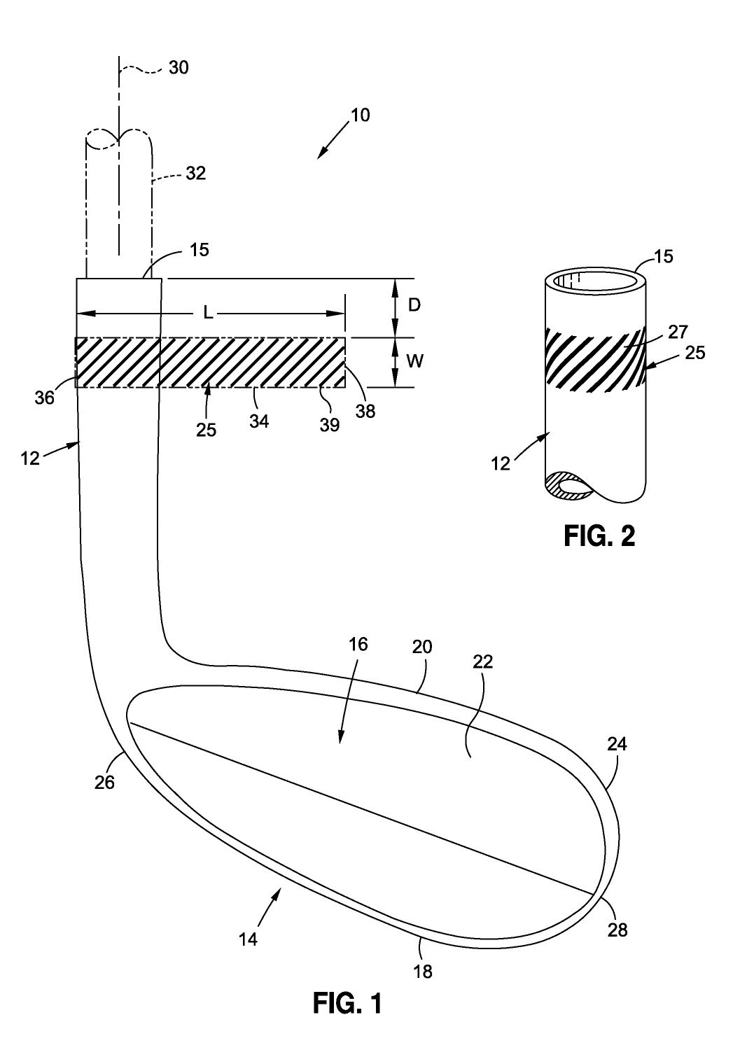

Referring now to FIG. 1, an exemplary iron-type club head 14 is shown, and generally comprises a main body 16 and a hosel 12 extending from the main body 16 and terminating at a top edge 15. The main body 16 includes a sole 18, a top portion 20, a rear portion 22, and a striking face 24 adapted to strike a golf ball. The main body 16 additionally includes a heel 26 and a toe 28 disposed at opposite end portions of the main body 16, wherein the striking face 24 generally extends between the heel 26 and the toe 28. The hosel 12 extends from the heel 26 and includes an outer surface disposed about a hosel axis 30. The hosel 12 includes a first end portion disposed adjacent the main body 16 and a second end portion extending away from the main body 16 and adapted to engage with a club shaft 32 of the golf club 10.

While the golf club 10 shown in FIGS. 1-3 is an iron-type golf club, it is contemplated that the present disclosure is also applicable to wood-type golf clubs, hybrids, and putters.

An exemplary indicia pattern 25 (resembling a traditional knurling pattern) is shown in FIG. 1 as extending within a two-dimensionalized indicia field 34 to more clearly depict the entirety of the indicia pattern 25, particularly that portion of the indicia pattern 25 which would extend out of view behind the hosel 12, from the perspective depicted in FIG. 1. For purposes of comparison, FIG. 2 shows indicia pattern 25 formed on a prescribed surface treatment region 27 of the hosel 12. The indicia field 34 includes a first end 36 and a second end 38 defining an indicia length, L, therebetween, and an upper edge 37 and a lower edge 39 defining an indicia width, W, therebetween. The indicia length L may be substantially equal to the circumference of the hosel 12, which results in the indicia pattern 25 extending completely around the circumference, e.g., the first indicia pattern 25 extending 360 degrees about the hosel axis 30. It is also understood that the indicia length L may be less than the circumference, and thus, may extend only partially around the hosel 12. For instance, the indicia pattern 25 preferably extends about the hosel axis 30 by no less than 15 degrees, more preferably no less than 25 degrees, and even more preferably no less than 50 degrees. These boundaries ensure that the applied indicia satisfy the intended visual and/or performance effect as described herein. Of course, in some embodiments, the indicia pattern 25 extends about the hosel axis by an amount outside of these bounds. According to one embodiment, the indicia width W is no less than 0.1 inches, although the indicia width W may be of other dimensions without departing from the spirit and scope of the present disclosure.

As will be described in more detail below, the indicia pattern 25 formed on the golf club 10 may be embodied in several different patterns, themes, or designs, which may mimic traditional-appearing knurling designs, or alternatively, may be associated with flags, banners, logos, alphanumeric content or other indicia.

According to one embodiment, the indicia pattern 25 is formed on the golf club 10 by directing a laser beam toward that surface of the golf club 10 upon which the indicia is desired. It is contemplated that in most instances, the indicia pattern 25 will be applied to at least a portion of the outer surface of a generally arcuately or cylindrically configured portion of the golf club 10 which may define a central axis about which the portion is radiused, such as the outer surface of the hosel 12 which extends about the hosel axis 30, or the outer surface of the shaft 32 which likewise extends about the hosel axis 30. The activation of the laser beam is coordinated with rotation of the golf club 10 about such rotational axis (e.g., the hosel axis 30) to form the indicia pattern 25 along at least a portion of the circumference of the outer surface of that generally cylindrically configured portion of the golf club 10 to which the laser beam is applied, the indicia length L of the indicia pattern 25 being dictated by the degree of rotation about the rotational axis. It is also contemplated that in addition to the golf club 10 being manipulated for such rotation about the aforementioned rotational axis, it may further be manipulated for incremental movement axially along the rotational axis, the indicia width W of the indicia pattern 25 being dictated by the degree of generally linear movement along the rotational axis.

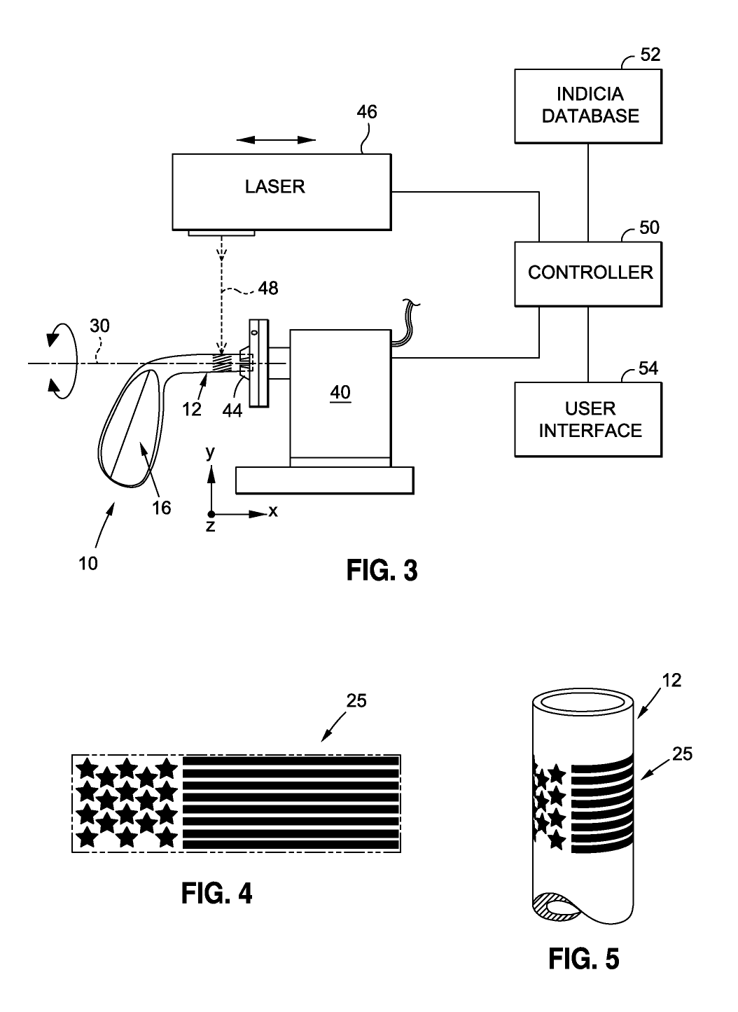

Referring now to FIG. 3, rotation of the golf club 10 may be controlled via an etching fixture 40 which is adapted to engage with the golf club 10 and rotate the golf club 10 about the hosel axis 30. In the exemplary embodiment, the etching fixture 40 includes an adjustable clamp 44 or chuck which may be selectively tightened around a portion of the golf club 10, such as the hosel 12 or the club shaft 32. According to one embodiment, the etching fixture 40 is capable of rotating the golf club 10 about the hosel axis 30 in a first rotational direction, as well as rotating the golf club 10 about the hosel axis 30 in an opposing second rotational direction, if needed, to create more intricate indicia designs for the indicia pattern 25. The etching fixture 40 is also operative to rotate the golf club 10 at a constant rotational speed or a variable rotational speed. Further, the etching fixture 40 may be configured to move the golf club 10 linearly along the hosel axis 30 to facilitate the aforementioned variation in the indicia width W. The rotational speed of the golf club 10 in a clockwise or counter-clockwise direction as well as the linear, axial movement of the golf club 10, as all controlled by the etching fixture 40, are correlated to the configuration of the prescribed indicia pattern 25.

The laser beam is emitted from a laser generator 46 along a laser axis 48, and is applied to a prescribed outer surface portion of the golf club 10. As indicated above, such outer surface portion is typically defined by a cylindrically or arcuately configured portion of the golf club 10, such as the hosel 12 which in FIG. 3 is depicted as having the laser beam applied thereto. The laser generator 46 may be capable of generating a laser beam having sufficient power for laser etching the indicia pattern 25 into a metallic surface of the golf club 10. In the exemplary implementation shown in FIG. 3, the hosel 12 of the club head 14 defines such metallic surface, though the shaft 32 may also define such surface assuming it is fabricated from a metal material rather than a non-metal material such as graphite and of a material known to change in appearance upon heating and/or application of a laser. When the laser beam impinges on that metallic outer surface portion of the golf club 10 to which it is applied, the laser beam may result in material removal of the metal material. In some cases, this material removal results in a groove or indentation within such outer surface. Alternative, or in addition, in some embodiments, the application of a laser to the surface of the metal results in a texture variation from adjacent surface environments that may generate visually distinction from such adjacent environments. According to one embodiment, the groove or indentation extends into the outer surface at a depth no greater than 0.25 mm, and more preferably at a depth no greater than 0.15 mm. It is contemplated that the strength of the laser beam may be varied to create different indicia depths or predetermined color patterns (of a spectrum of colors, hues and/or tints) for the indicia pattern 25.

The laser generator 46 and the etching fixture 40 are in communication with a controller 50 adapted to control and coordinate the operation of the laser generator 46 and etching fixture 40 to produce the desired indicia pattern 25 on the golf club 10. In this respect, the controller 50 may have computer executable instructions stored thereon for controlling and coordinating the laser generator 46 and/or the etching fixture 40 for etching the indicia pattern 25 into the golf club 10. Specifically, the controller 50 may receive or contain instructions to control the motion of the laser generator 46, the fixture 40 and/or both. The motion of each of laser generator and the fixture may include translational motion in a planar and/or spatial region and/or rotational motion relative to a predetermined set of axes defining a two-dimensional or three-dimensional space. Preferably, the controller receives, or has stored thereon, information for controlling the motion of the laser generator limited to a two-dimensional planar space, and motion of the fixture 40 limited to rotation about a single axis. More preferably, the controller 50 receives, or has stored thereon, information for controlling the motion of the laser generator in a manner limited to translational motion about a single axis (i.e. in a single dimension). Additionally, or alternative, the information received by, or stored on, the controller 50 includes information for setting (and varying during a programmed application) attributes of the laser, e.g. power, wavelength, temperature, and width, for varying the visual and/or material effect on substrate of the laser over the course of a programmed application. In some embodiments, the controller 50 is configured to enable the laser to rotate, while the fixture 40 remains generally fixed. Preferably, in some such embodiments, the laser is programmed to rotate about a predetermined axis, e.g. a central axis defined by an arcuate or radiused portion of the golf club head 10. Even more preferably, in such embodiments, the laser rotates such that the laser axis 48 remains perpendicular to the general surface contour of the golf club 10 intended to be marked.

The controller 50 may be in communication with an indicia database 52 having stored sets of commands for the etching fixture 40 and the laser generator 46 to create the indicia pattern 25 in any one of a multiplicity of different patterns. For instance, the stored commands may correspond to the power level of the laser beam, the rotational speed and direction of golf club 10 as well as the linear movement of golf club 10 along the rotational axis as all controlled by the etching fixture 40, and the coordinated timing of the laser beam emission and club rotation/linear movement. The user may be able to select a particular indicia pattern 25 to be etched into the golf club 10 via a user interface 54, which is in electrical communication with the controller 50. The user interface 54 may include a display for depicting exemplary design options for the indicia pattern 25 as stored on the indicia database 52, and an input to allow the user to select one of the various designs options.

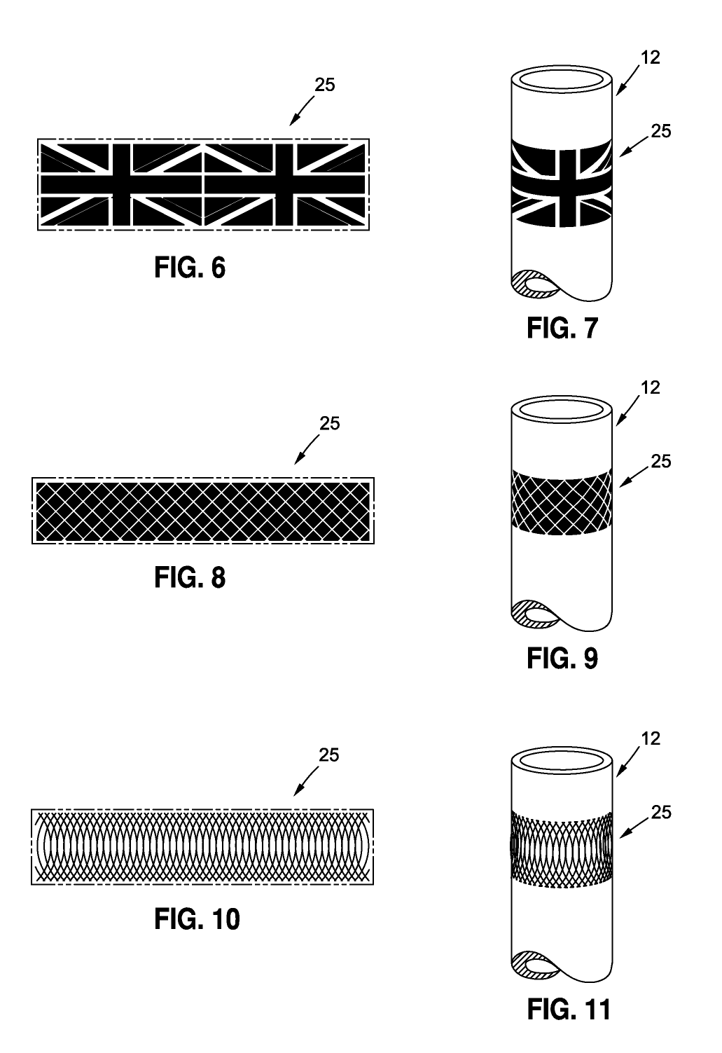

Referring now to FIGS. 4-11, there is depicted several exemplary indicia designs for the indicia pattern 25 which may be laser etched into the golf club 10 at, for example, the surface treatment region 27 of the hosel 12 shown in FIG. 2. In particular, FIGS. 4, 6, 8, and 10 depict different indicia designs for the indicia pattern 25 displayed in respective two-dimensional design fields, whereas FIGS. 5, 7, 9, and 10 show the indicia designs of FIGS. 4, 6, 8, and 10, respectively, formed on the hosel 12 of the club head 14. As is apparent from FIGS. 4-11, the exemplary indicia designs for the indicia pattern 25 may be associated with national flags, such as the stars-and-stripes design in FIGS. 4 and 5 (evoking the flag of the United States), and the Union Jack design in FIGS. 6 and 7 (evoking the flag of the United Kingdom). Other exemplary indicia designs for the indicia pattern 25, varying from that shown in FIGS. 1 and 2, may comprise linear elements in a hatched arrangement (having likeness of a knurling pattern) and highlighted by a background color of the surface treatment region 27 which differs from the remainder of the hosel 12 as shown in FIGS. 8 and 9, as well as rounded or arcuate elements (having likeness of a surface milled pattern) as shown in FIGS. 10 and 11. It is also contemplated that the indicia pattern 25 may include a combination of linear elements and arcuate elements. The indicia designs for the indicia pattern 25 may include recurrent patterns, symmetrical patterns, asymmetrical designs, traditional knurling patterns, etc. Indeed, as indicated above, those skilled in the art will readily appreciate that the indicia designs depicted in FIGS. 1-2 and 4-11 are exemplary only, and are not intended to limit the scope of the present disclosure.

According to one embodiment, the method of laser etching the indicia onto the golf club 10 is as follows. The etching fixture 40 is prepared for engagement with the golf club 10 by opening the clamp 44 to allow a portion of the club 10 (e.g., the club shaft 32 or hosel 12) to be inserted into the open clamp 44. The golf club 10 is inserted into the open clamp 44 and with the golf club 10 being positioned such that the outer surface portion thereof which will ultimately define the etched surface treatment region 27 is properly aligned with the laser axis 48. For example, the laser axis 48 is preferably oriented to be generally perpendicular to the surface of the substrate material. This orientation is preferable at point of initial configuration. Further, it is preferred that the controller 50 is programmed to maintain this general orientation over the majority of the surface-treating program, e.g. by varying the position of the laser and/or golf club 10 as affixed in the fixture 10 over the course of the surface-treating program. Once the golf club 10 is inserted therein, the clamp 44 is transitioned to the closed position and is tightened onto the golf club 10 to secure the same therein. It is understood that the golf club 10 will most likely have an uneven weight distribution relative to the rotational axis, and thus, the clamping force exerted by the clamp 44 onto the golf club 10 will be sufficient to remain engaged with the golf club 10 even as it spins about the rotational axis.

The user may view the available indicia designs available for use as the indicia pattern 25 as stored in the indicia database 52 on a display associated with the user interface 54. Upon deciding upon an indicia design, the user makes a selection corresponding to the desired design. The controller 50 then sends operational commands to the laser generator 46 and the etching fixture 40 in accordance with the selected indicia design. In particular, the laser generator 46 is actuated to generate the laser beam and direct the laser beam toward the prescribed outer surface portion of the golf club 10. The etching fixture 40 is actuated to rotate and/or linearly move the golf club 10 in the aforementioned manner in coordination with the emission of the laser beam by the laser generator 46. The emission of the laser beam and the rotation of the golf club 10 alone or in combination with the linear movement thereof by operation of the etching fixture 40 continues until the indicia design is completely etched on the golf club 10 (i.e., the indicia pattern 25 is fully formed at the surface treatment region 27), at which time the laser beam may be deactivated and the etching fixture 40 will bring the rotation and/or linear movement of the golf club 10 to a stop. Once the golf club 10 stops moving, it may be removed from the etching fixture 40 by opening the clamp 44. The impingement of the laser beam onto the golf club 10 may result in the golf club 10 being hot, and therefore, it may be advisable to let the golf club 10 cool before removing it from the etching fixture 40.

Although the foregoing describes forming the indicia onto the golf club 10 via laser etching, it is understood that other etching or metal surface treatment techniques may be used for forming the indicia. Along these lines, several different etching or surface treatment techniques may be employed in combination with rotation and/or linear movement of the golf club 10 for forming intricate designs. For instance, exemplary etching and metal surface treatment techniques may include, but are not limited to chemical etching, media blasting, transfer-printing, painting, coating, physical vapor deposition, anodization, and other techniques known by those skilled in the art.

It is contemplated that the scope of the present disclosure is not limited to golf clubs. Rather, the disclosure also encompasses other elongate recreational equipment which may have indicia formed thereon, such as baseball bats, fishing rods, hockey sticks, lacrosse sticks, etc.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

1: A method comprising:
(a) directing a laser beam onto a hosel of a golf club head; and
(b) etching a prescribed indicia corresponding to a knurling pattern into the hosel of the golf club head by:
at least one of: (i) rotating the golf club head relative to the laser beam; and (ii) rotating the laser beam relative to the golf club head.

2: The method recited in claim 1, wherein step (b) further comprises etching the prescribed indicia into the arcuate exterior surface of the hosel of the club head.

3. (canceled)

4: The method of claim 1, wherein step (b) comprises rotating the golf club head or the laser beam at at least one of a constant rotational speed or a variable rotation speed.

5: The method of claim 1, wherein step (b) further comprises etching the knurling pattern into the hosel of the golf club head by at least one of: (i) moving axially the golf club head relative to the laser beam; and (ii) moving axially the laser beam relative to the golf club head.

6: The method of claim 1, wherein the rotation in accordance with step (b) and the directing of the laser beam onto the golf club in accordance with step (a) are controlled and coordinated by computer executable instructions corresponding to the prescribed indicia.

7: The method of claim 3, wherein the laser beam defines a beam axis, and step (a) comprises aligning the laser with the hosel such that the beam axis extends generally perpendicularly relative to the hosel axis.

8: The method of claim 1, wherein step (b) comprises etching the prescribed indicia into the exterior surface of the hosel of the golf club head about an entire circumference thereof.

9: The method of claim 3, wherein step (b) comprises etching the knurling pattern into the exterior surface of the hosel such that the knurling pattern circumferentially extend about the hosel axis about at least 25°.

10: A golf club head comprising:
a main body including a striking face adapted to strike a golf ball; and
a hosel extending from the main body, the hosel including an exterior surface and defining a hosel axis;
the exterior surface of the hosel having a knurling pattern laser etched thereinto, the knurling pattern circumferentially extending about the hosel axis by about at least 25°.

11: The golf club head recited in claim 10, wherein the knurling circumferential extend about the hosel axis by about at least 30°.

12: The golf club head recited in claim 10, wherein the knurling extend about the entire circumference of the hosel.

13: The golf club head recited in claim 10, wherein the knurling comprise a plurality of indicium forming a recurrent pattern.

14. (canceled)

15: A golf club head comprising:
a main body including a striking face adapted to strike a golf ball; and
a hosel extending from the main body, the hosel including an exterior surface and defining a hosel axis, the exterior surface of the hosel having a surface-treatment region thereon constituting indicia resembling a knurling pattern, the indicia having a depth no greater than 0.15 mm.

16: The golf club head recited in claim 15, wherein the surface treatment region is a region selected from a group consisting of: a chemical-etched region, a laser-etched region, a media-blasted region, a transfer-printed region, a painted region, a coated region, a physical vapor deposition region, and an anodization region.

17: The golf club head recited in claim 16, wherein the surface treatment region is a laser-etched region.

18: The golf club head recited in claim 15, wherein the indicia comprise a width no less than 0.1 in.

19: The golf club head recited in claim 15, wherein the indicia circumferentially extend about the hosel axis no less than about 25°.

20: The golf club head recited in claim 19, wherein the indicia circumferentially extend substantially entirely about the hosel axis.
